(19) United States
(12) Patent Application Publication
(10) Pub. No.: US 2012/0036144 A1
(43) Pub. Date: Feb. 9, 2012

(54) INFORMATION AND RECOMMENDATION DEVICE, METHOD, AND PROGRAM

(75) Inventors: Masayuki Okamoto, Kawasaki-shi (JP); Nayuko Watanabe, Yokohama-shi (JP); Masaaki Kikuchi, Kawasaki-shi (JP); Takayuki Iida, Tokyo (JP); Mika Fukui, Tokyo (JP)

(73) Assignee: KABUSHIKI KAISHA TOSHIBA, Tokyo (JP)

(21) Appl. No.: 13/217,875

(22) Filed: Aug. 25, 2011

Related U.S. Application Data
(63) Continuation of application No. PCT/JP2010/051436, filed on Feb. 2, 2010.

(30) Foreign Application Priority Data
Feb. 27, 2009 (JP) 2009-046795

(51) Int. Cl. G06F 17/30

(52) U.S. Cl. 707/758; 707/E17.022

(57) ABSTRACT

According to one embodiment, an information recommendation device includes following units. The input unit is configured to input a first document and a second document which has been browsed before the first document. The subject-keyword extraction unit is configured to extract first and second subject keywords from the first and second documents, respectively. The interest-keyword extraction unit is configured to extract first interest keywords from the first and second subject keywords, and to extract second interest keywords based on information specifying the first and second documents, the first interest keywords, and the first and second subject keywords. The second interest keywords are estimated to be keywords in which the user is next interested. The acquiring unit is configured to acquire, based on the second interest keywords, recommendation information on third documents which are candidates to be browsed after the first document. The presentation unit presents the recommendation information.

### CROSS REFERENCE TO RELATED APPLICATIONS

This application is a Continuation Application of PCT Application No. PCT/JP2010/051436, filed Feb. 2, 2010 and based upon and claiming the benefit of priority from prior Japanese Patent Application No. 2009-046795, filed Feb. 27, 2009, the entire contents of all of which are incorporated herein by reference.

### FIELD

Embodiments described herein relate generally to an interest extraction device and an interest extraction method, which determine what part of text information such as a web page or a manuscript a user browsing the text information is interested in and recommend information suitable for the user.

### BACKGROUND

There have been demands for determining what part of text information (also called a “document”) such as a web page or a manuscript a user browsing the text information is interested in, and for recommending information suitable for the user. For devices of this type, a proposal has been made for technology for updating importance degrees of keywords located near keywords being operated in a page (for example, see JP-A 2001-188792 (KOKAI)).

However, according to the method described above in which keywords included in a page are simply extracted and subjected to a search, there is a case that different search results, such as homonyms, are presented. There is another case that, even when one same document is browsed, which content attracts attention differs depending on context. Since an interesting point cannot adequately be determined, how much a recommended content matches an interest of a user can not be estimated when the recommended content is presented. Among conventional proposals, the technology for searching relevant documents with a focus on the periphery of a word pointed on a page does exist. However, there is no technological proposal for presenting content to be recommended for a document to be browsed next to the present document, based on an interest on an immediately preceding document.

### BRIEF DESCRIPTION OF THE DRAWINGS

FIG. 1 is a functional block diagram showing an interest extraction device according to an embodiment;

FIG. 2 is a chart showing a flowchart of an interest extraction device according to the embodiment;

FIG. 3 is a view showing an example of browsing information according to the embodiment;

FIG. 4 is a table showing an example of information extracted by a subject-keyword extraction unit in the interest extraction device according to the embodiment;

FIG. 5 is a table showing an example of information extracted by an interest-keyword extraction unit in the interest extraction device according to the embodiment;

FIG. 6 is a table showing an example of information extracted by the subject-keyword extraction unit in the interest extraction device according to the embodiment;

FIG. 7 is a table showing an example of information for generating a query, which is extracted by the interest-keyword extraction unit in the interest extraction device according to the embodiment;

FIG. 8 is a table showing an example of information stored in a chain-rule storage unit in the interest extraction device according to the embodiment; and

FIG. 9 is a view showing an example of information presented on a recommendation-information presentation unit according to the embodiment.

### DETAILED DESCRIPTION

In general, according to one embodiment, an information recommendation device includes an input unit, a subject-keyword extraction unit, an interest-keyword extraction unit, an interest-keyword extraction unit, an acquiring unit and a presentation unit. The input unit is configured to input a first document browsed by a user, and a second document which has been browsed before the first document. The subject-keyword extraction unit is configured to extract one or more first subject keywords from the first document, and to extract one or more second subject keywords from the second document. The interest-keyword extraction unit is configured to extract one or more first interest keywords from the first subject keywords and the second subject keywords, and to extract one or more second interest keywords from the first subject keywords and the second subject keywords, based on information items specifying the first document and the second document, the first interest keywords, the first subject keywords, and the second subject keywords, the second interest keywords being estimated to be keywords in which the user is next interested. The acquiring unit is configured to acquire, based on the second interest keywords, recommendation information items on one or more third documents which are candidates to be browsed after the first document. The presentation unit is configured to present the recommendation information items.

Hereinafter, various embodiments will be described with reference to the accompanying drawings.

According to one embodiment, content/service recommendations can be adequately performed so as to match a user's interest. For example, when a user browses a page relevant to “grilled chicken-wing-tip restaurant in Kawasaki”, “Kawasaki” is understood to be an interest point if the user browsed a page of “French restaurant in Kawasaki” immediately before, or “chicken-wing-tip” is understood to be an interest point if the user browsed “grilled chicken-wing-tip restaurant in Yokohama” immediately before. Accordingly, content recommendation is possible with basing information to be presented next on keywords which more match a user's interest than important keywords derived only from a document being presently browsed, by a search considering an interest point (continuation of an interest) or recommendation of or a search for relevant keywords based on transition of an interest.

The following embodiment will be described based on the assumption that an interest extraction device 100 is included in a server and an information presentation device 200 is included in a terminal owned by a user. However, the same as described also applies to a case of including the interest extraction device 100 and information presentation device 200 in one same terminal. Further, the embodiment mainly deals with web pages as information or documents to be browsed. A web page which internally includes a still image and/or a moving image may be dealt with in the same manner as the aforementioned web pages.

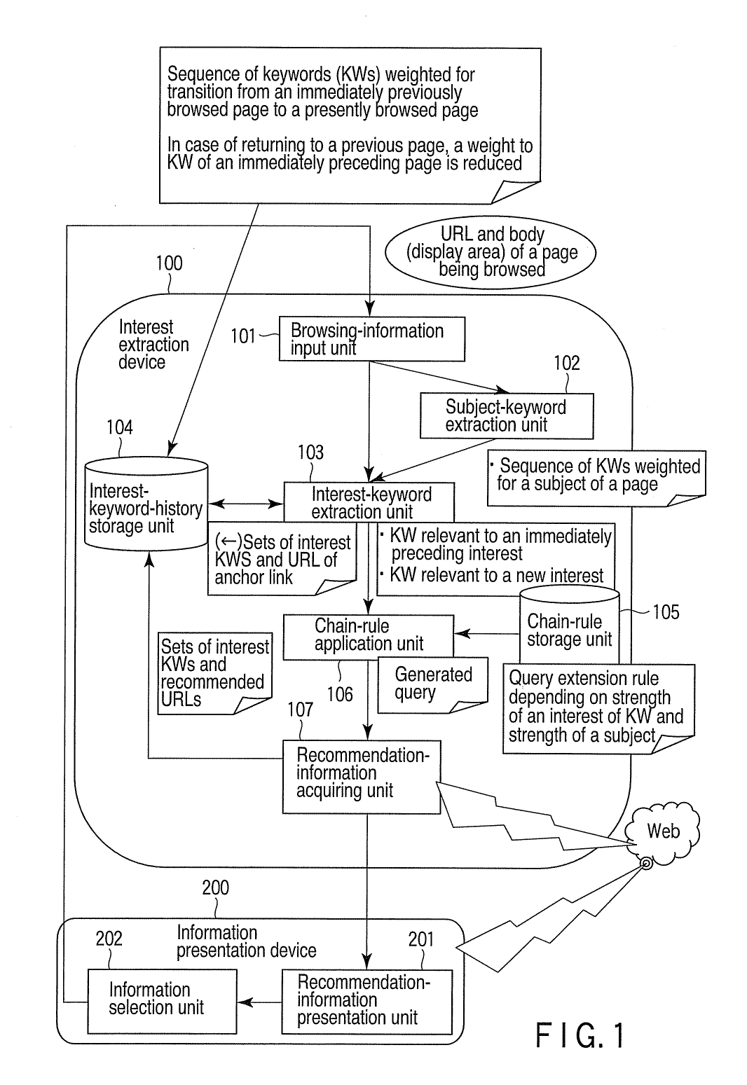

FIG. 1 is a functional block diagram showing the interest extraction device 100 according to the embodiment. In the interest extraction device 100 shown in FIG. 1, a browsing-information input unit 101 receives, from the information presentation device 200, a URL or displayed content of a document (for example, a web page) being browsed. A subject-keyword extraction unit 102 extracts one or more subject keywords of the document from text information input by the browsing-information input unit 101. The text information includes a title, a body, and the like of the document. An interest-keyword extraction unit 103 extracts one or more interest keywords, which correspond to keywords expressing a present interest of a user, from the text information and the subject keywords extracted by the subject-keyword extraction unit 102. The interest-keyword extraction unit 103 then stores, in an interest-keyword history storage unit 104, the extracted interest keywords and URLs associated with each other in sets. Chain rules, each of which is a method for searching for a next document in accordance with at least one interest keyword, are stored in a chain-rule storage unit 105. A chain-rule application unit 106 generates a search query by applying the chain rule stored in the chain-rule storage unit 105 to the interest keyword extracted by the interest-keyword extraction unit 103. A recommendation-information acquiring unit 107 searches for candidates for content to be recommended next, by using the search query generated by the chain-rule application unit 106, thereby acquiring recommendation information. In the information presentation device 200, the recommendation information acquired by the recommendation-information acquiring unit 107 is presented through a recommendation-information presentation unit 201. The user can select information to be browsed next from the presented recommendation information, by using an information selection unit 202. The information selection unit 202 is configured to select information to be browsed next in accordance with input from the user.

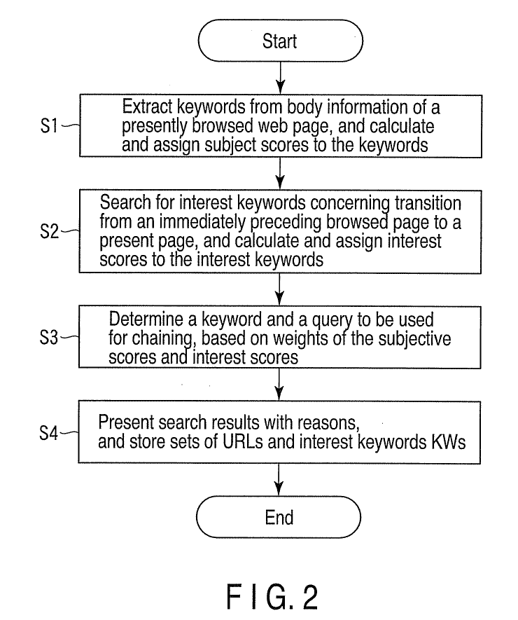

Next, the interest extraction device 100 will be described with reference with FIG. 2. FIG. 2 is a flowchart showing operation of the interest extraction device 100 according to the present embodiment.

At first, subject keywords are extracted from text information of a web page (URL(t)) which the user presently browses, and subject scores are calculated and assigned to the subject keywords (step S1). In the present embodiment, positions of the keywords on the web page are used to calculate the subject scores. For example, a keyword existing in a title or located in the fore part of a body is assigned with a high score.

Further, a correction depending on a display area may be performed. For example, a keyword, which originally located in the back part of the body and is assigned with a low score, obtains a high score when the keyword is displayed at a high position as the web page moves up.

Next, interest keywords concerning transition to the present web page (URL(t))from a web page (URL(t-1)) which has been browsed immediately before are searched for, and interest scores are calculated and assigned to these interest keywords (step S2). A detection method for detecting the interest keywords is one in which, for example, when a hyperlink in a body is clicked, keywords in the periphery of the hyperlink are regarded as interest keywords. A calculation method for calculating the interest scores is one in which, for example, an interest score increases as a corresponding interest keyword is closer to a keyword or hyperlink which the user clicked or paid attention to.

Next, one or more keywords and queries to be used for chaining are determined based on weights of the calculated subject scores and the interest scores (step S3). In this case, a search method for a query and a presentation method are determined referring to chain rules stored in the chain-rule storage unit 105 by using the subject scores and interest scores. The chain rules will be described later. Further, a search result is presented, added with a reason, and sets of the interest keywords and the URLs of web pages are stored in the interest-keyword-history storage unit 104 (step S4). Processing then ends. Presentation of the search result added with the reason denotes to display the interest keywords by using a presentation method in a chain rule.

Next, operation of the interest extraction device 100 according to the embodiment will be described with reference to FIGS. 1 and 2.

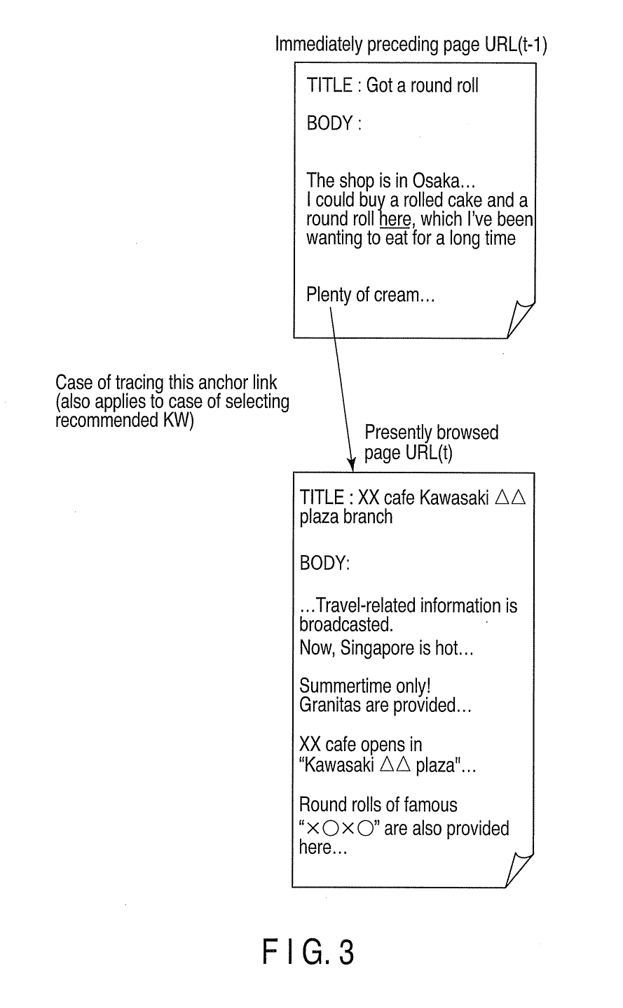

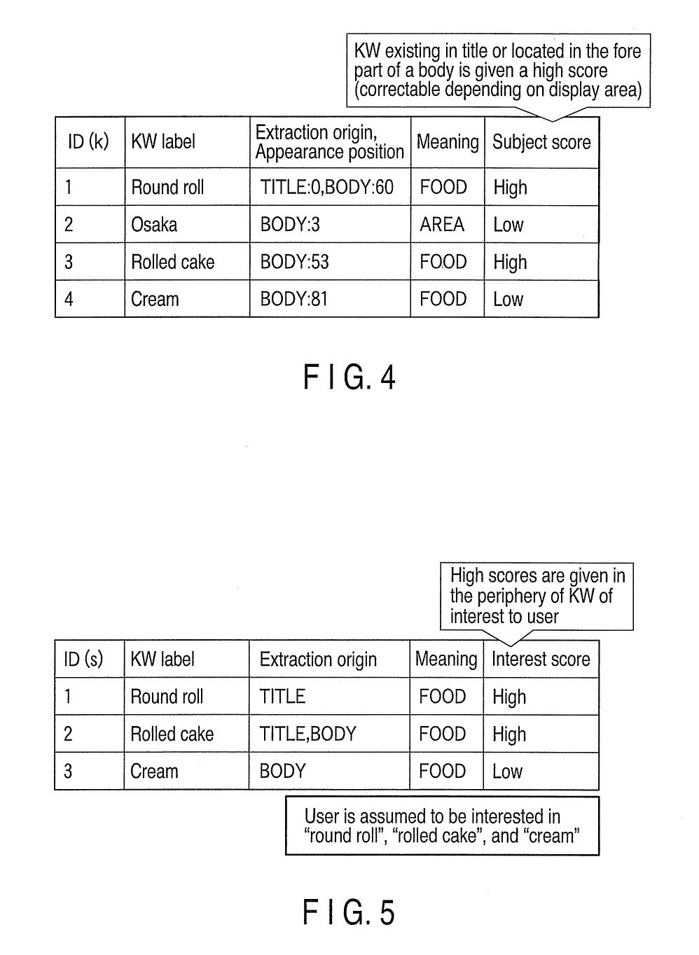

At first, the user browses a web page through the information selection unit 202 by using the information presentation device 200. FIG. 3 shows an example of text included in browsing information. In FIG. 3, the present page URL(t) is supposed to be presently browsed by selecting an anchor link including a word “here” among sentences included in the immediately preceding page URL(t-1). The browsing-information input unit 101 inputs text information included in the selected web page. In FIG. 3, TITLE means a title of the page, and BODY means a body of the page. Next, the subject-keyword extraction unit 102 extracts subject keywords from text information, and assigns subject scores to the subject keywords. FIG. 4 shows subject keywords extracted when the page URL(t-1) immediately before the presently browsed web page URL(t) is browsed. Morphological analysis and named entity extraction are used to extract the keywords. For the respective keywords, calculated/determined are consecutive IDs, labels of the extracted keywords, origins of the extracted keywords, such as TITLEs and BODYs, appearance positions respectively indicating what numbered characters the extracted keywords appear at, meaning classes of the extracted keywords, and subject scores of the extracted keywords. In the present embodiment, an extracted subject keyword which appears in a title is given a higher score. Further, the closer to the top of a body an extracted keyword appears, the higher the score the extracted keyword is given. An extracted keyword which appears both in a title and a body is given a much higher score.

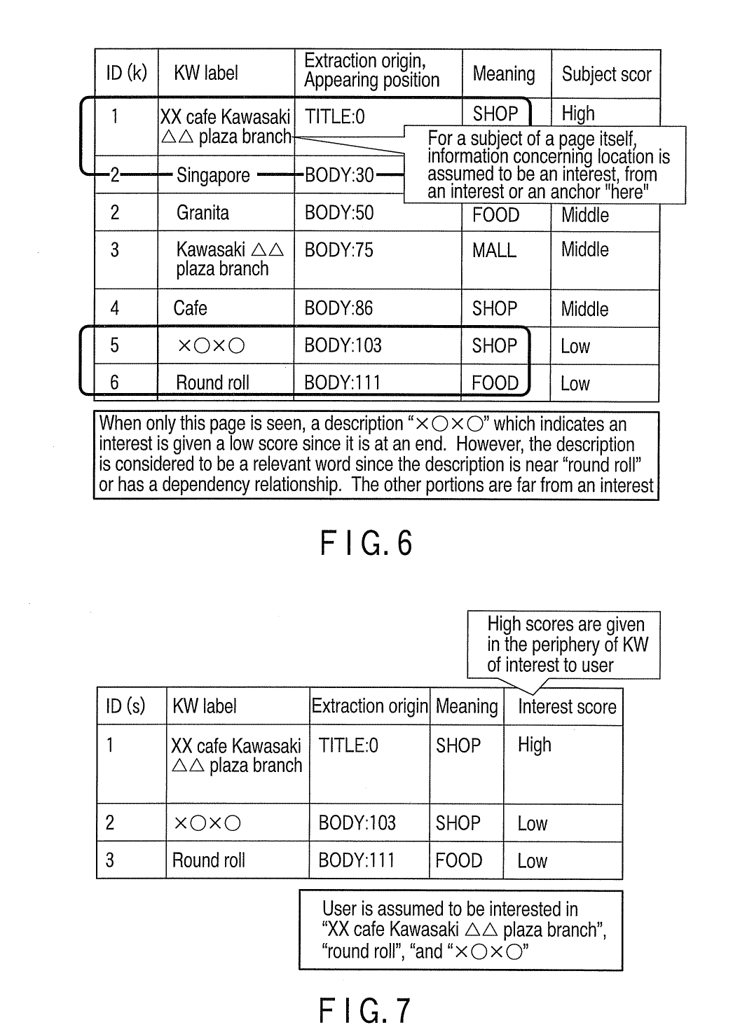

Next, the interest-keyword extraction unit 103 associates a keyword included in the page being browsed with a URL of a next page, as an interest keyword. For example, the expression “here” in the body of the URL(t-1) in FIG. 5 is a hyperlink to the URL(t). In this case, “round roll”, “rolled cake”, and “cream”, which are keywords existing in the periphery of the expression “here”, can be considered to be words which express interests in the URL(t). FIG. 6 shows a list of interest keywords associated with transition from the URL(t-1) to the URL(t). The interest keywords are extracted from the subjected keywords extracted by subject keyword extraction 103. For the respective interest keywords, consecutive IDs, labels of the extracted keywords, origins of the extracted keywords, meaning classes of the keywords, and interest scores are determined or calculated. Here, the closer to the anchor text an extracted keyword is, the higher the interest score the extracted keyword is given. Sets of URLs corresponding to the transition and the interest keywords are stored into the interest-keyword-history storage unit 104.

Assume that the interest keywords in the above paragraph are stored in the interest-keyword-history storage unit 104 and the web page at the URL(t) is browsed. Then, descriptions existing in the periphery of the words “round roll” and “rolled cake” are considered to be interested in if an interest concerning transition to the page at the URL(t) from the page at the URL(t-1) is continued. Otherwise, “XX cafe Kawasaki ΔΔ plaza branch” which is a subject of the page being newly browsed is considered to be of new interest. The interest-keyword extraction unit 103 extracts “XX cafe Kawasaki ΔΔ plaza branch”, which is a keyword given a high subject score, “XoXo” which is a keyword appearing in the vicinity of the interest keyword “round roll” indicating a transition traced this time, and a set of “round roll” and “XoXo”, as new interest keywords for searching for and presenting recommendation information. FIG. 7 shows extracted interest keywords for generating a search query.

Then, a search query is generated, by the chain-rule application unit 106, based on the extracted interest keywords. The chain-rule application unit 106 selects, from the chain rules stored in the chain-rule storage unit 105, an applicable chain rule based on the subject scores, interest scores, and meaning classes of the interest keywords.

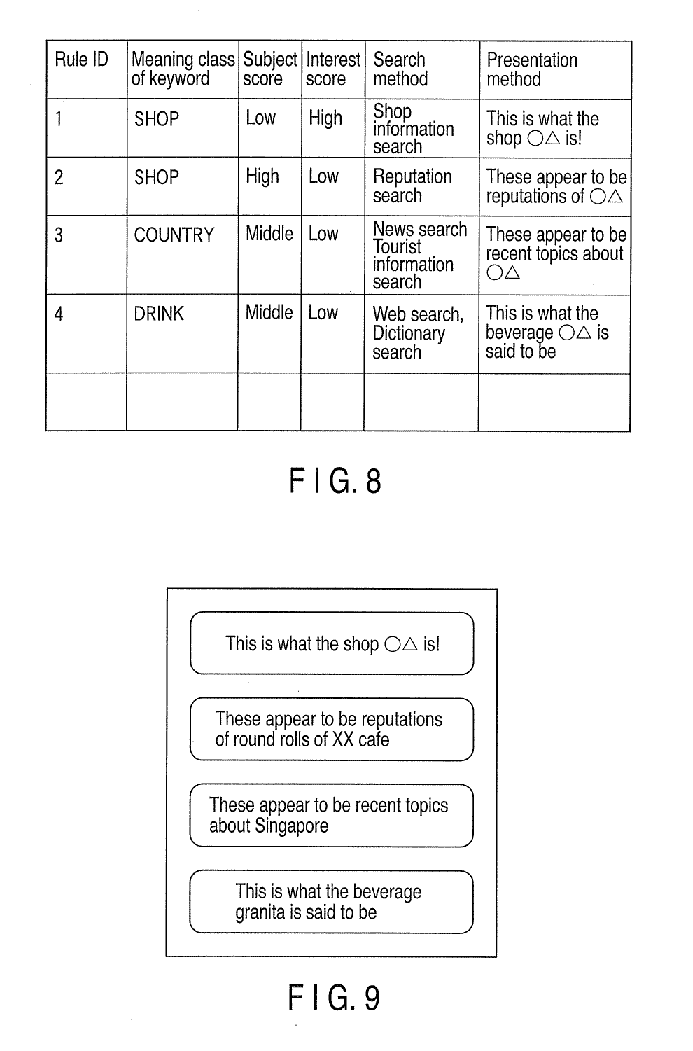

FIG. 8 shows an example of the chain rules stored in the chain rules storage unit 105. The list shown in FIG. 8 includes rule IDs indicating consecutive numbers of the rules, meaning classes of keywords, subject scores of the keywords, interest scores of the keywords, search methods to be selected, and presentation methods. Search services such as specific web services and searches which specify target domains are assumed as the search methods. The presentation methods are templates for caption information used when recommendation is finally performed. For example, there is a description “This is what the shop oΔ is!” at a rule ID 1, and a specific interest keyword is substituted for oΔ. The description is then displayed as “This is what shop XoXo is!”.

Concerning keywords extracted from FIG. 6, for example, a query “XoXo AND round roll” for shop information search services is searched for from a set of a food “round roll” and a shop “XoXo”, based on the rule ID 1.

A search is actually performed by the recommendation-information acquiring unit 107 in accordance with the search query generated by the chain-rule application unit 106. Although the embodiment is assumed as performing a search using a web service, a search method other than a web service may be used, such as a database search from a dictionary stored in the interest extraction device 100.

URLs as results acquired by the recommendation-information acquiring unit 107 are stored in the interest-keyword-history storage unit 104, each combined in a set with an interest keyword upon which the query is based.

The results acquired by the recommendation-information acquiring unit 107 are presented to the user through the information presentation device 200 by the recommendation-information presentation unit 201, by using a presentation method described in a chain rule stored in the chain-rule storage unit 105. When the user selects one of presented contents, a web page corresponding to a URL as a recommendation result is then displayed as a page being browsed on the information presentation device 200. FIG. 9 shows an example of finally presented content. In the embodiment, to select an item of information presentation content presented by the recommendation-information presentation unit 201 during browsing of a web page is to always perform browsing in a state where an interest keywords and a URL are combined in a set, as in a case of selecting a hyperlink on a web page corresponding to the URL(t). Accordingly, the interest extraction device 100 can recommend information, tracing an interest of the user.

Thus, when the user browses a web page, interest information can be extracted and information can be recommended in accordance with an interest.

Although the present embodiment uses only keywords included in a page browsed immediately before, as interest keywords, a method for decreasing scores by a function of n, such as 1/n, may be used for n-page preceding keywords.

The browsing-information input unit 101 may input a keyword expressing a situation which the user is presently in, in addition to a web page. For example, if a web browser is installed in a mobile terminal, a word such as “Kawasaki” is considered to be input as a keyword expressing a present location.

The present embodiment assumes that the interest extraction device 100 is used in a server and the information presentation device 200 is used in a terminal owned by a user. However, the interest extraction device 100 and information presentation device 200 may be configured to be integrated with each other. The interest extraction device 100 is applicable even to a popular computer which includes a control device such as a CPU, a storage device such as a ROM or RAM, an external storage device such as an HDD, a display device such as a monitor, and input devices such as a keyboard and a mouse.

The interest extraction device 100 in the above embodiment can also be achieved by using, for example, a general-purpose computer device as basic hardware. A program to be executed configures a module including each of the functions as described above. The program may be provided recorded in a recording medium, such as a CD-ROM, floppy (registered trademark) disc, CD-R, or DVD, which is readable from computers, or may be provided preinstalled in a ROM.

Alternatively, the interest extraction device 100 can be achieved by using, for example, a general-purpose computer device as basic hardware. That is, the browsing-information input unit 101, subject-keyword extraction unit 102, interest-keyword extraction unit 103, chain-rule application unit 106, recommendation-information acquiring unit 107, recommendation-information presentation unit 201, and information selection unit 202 can be achieved by causing a processor mounted in the computer device to execute a program. At this time, the interest extraction device 100 can be achieved by pre-installing the aforementioned program in the computer device. Alternatively, the aforementioned program may be stored in a storage medium such as a CD-ROM or distributed through a network, and the program can then by achieved by appropriately installing the program in the computer device. Further, the interest-keyword-history storage unit 104 and chain-rule storage unit 105 can be achieved by appropriately using a storage medium such as a memory, hard disc, CD-R, CD-RW, DVD-RAM, or DVD-R, which is built in or externally attached to the computer device.

Hereinafter, an information recommendation device according to one embodiment will be supplementarily described.

(1) An information recommendation device according to one embodiment includes: an input unit configured to input a plurality of documents; a subject-keyword extraction unit configured to extract one or more subject keywords from a predetermined document and a document immediately preceding the predetermined document; an interest-keyword extraction unit configured to extract one or more interest keywords from the subject keywords of the immediately preceding document and the predetermined document; an interest-keyword-history storage unit configured to store the interest keywords, wherein the interest-keyword extraction unit further extracts one or more next interest keywords which a user is likely to be next interested in, based on information specifying the predetermined document, the interest keywords, and the subject keywords of the predetermined document; an acquiring unit configured to acquire one or more next documents next to the predetermined document, based on the next interest keywords; and a presentation unit configured to present the next documents.

(2) In the information recommendation device according to the (1), the interest-keyword extraction unit extracts the interest keywords in consideration of transition to the predetermined document from the subject keywords of the immediately preceding document.

(3) In the information recommendation device according to the (1), the input unit acquires the predetermined document itself, based on the information specifying the predetermined document.

(4) In the information recommendation device according to the (1), the input unit acquires a title, a summary, and a body area from the predetermined document.

(5) The information recommendation device according to the (1) further includes a chain-rule storage unit configured to store a search rule for chaining to a next piece of content based on types of the interest keywords extracted by the interest-keyword extraction unit, and a chain-rule application unit configured to generate a search query based on the interest keywords and chain rule.

(6) The information recommendation device according to the (1) further includes an information selection unit configured to select a next document from the next documents presented by the presentation unit.

(7) In the information recommendation device according to the (1), the interest-keyword extraction unit inputs an additional keyword which expresses a situation of a user, such as a location of the user or an action of the user.

(8) In the information recommendation device according to the (1), the interest-keyword extraction unit extracts interest keywords included in documents which have been browsed within a predetermined range up to a preceding plurality of times, with weights.

(9) In the information recommendation device according to the (1), if a browsed document is browsed again, the interest-keyword extraction unit decreases scores for interest keywords included in the document browsed immediately before.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information recommendation device comprising:
an input unit configured to input a first document browsed by a user, and a second document which has been browsed before the first document;
a subject-keyword extraction unit configured to extract one or more first subject keywords from the first document, and to extract one or more second subject keywords from the second document;
an interest-keyword extraction unit configured to extract one or more first interest keywords from the first subject keywords and the second subject keywords, and to extract one or more second interest keywords from the first subject keywords and the second subject keywords, based on information items specifying the first document and the second document, the first interest keywords, the first subject keywords, and the second subject keywords, the second interest keywords being estimated to be keywords in which the user is next interested;
an acquiring unit configured to acquire, based on the second interest keywords, recommendation information items on one or more third documents which are candidates to be browsed after the first document; and
a presentation unit configured to present the recommendation information items.

2. The device according to claim 1, wherein the interest-keyword extraction unit extracts, as the first interest keywords, (1) at least one second subject keyword which is located in a predetermined range including a keyword selected by the user during browsing of the second document, and (2) at least one first subject keyword which is located in a predetermined range including a same keyword as any one of one or more first interest keywords extracted from the second document.

3. The device according to claim 1, wherein the input unit acquires the first document and the second document themselves based on the information items specifying the first document and the second document, respectively.

4. The device according to claim 1, wherein the input unit acquires a title, a summary, and a body area which are included in each of the first document and the second document.

5. The device according to claim 1, further comprising:
a chain-rule storage unit configured to store a chain rule for searching for the third documents based on types of the first interest keywords; and
a chain-rule application unit configured to generate a search query based on the second interest keywords and the chain rule.

6. The device according to claim 1, further comprising an information selection unit configured to select a recommendation information item from the recommendation information items presented by the presentation unit.

7. The device according to claim 1, wherein the interest-keyword extraction unit inputs an additional keyword expressing a situation of the user, the situation including a location or action of the user.

8. The device according to claim 1, wherein the interest-keyword extraction unit further extracts interest keywords with weights from fourth documents, the fourth documents having been browsed within a predetermined range before the first document and including the second document.

9. The device according to claim 1, wherein if a fifth document which has been browsed before is browsed again, the interest-keyword extraction unit decreases scores for interest keywords extracted from a sixth document which had been browsed immediately before the fifth document browsed again.

10. An information recommendation method comprising:
inputting a first document browsed by a user, and a second document which has been browsed before the first document;
extracting one or more first subject keywords from the first document;
extracting one or more second subject keywords from the second document;
extracting one or more first interest keywords from the first subject keywords and the second subject keywords;
extracting one or more second interest keywords from the first subject keywords and the second subject keywords, based on information items specifying the first document and the second document, the first interest keywords, the first subject keywords, and the second subject keywords, the second interest keywords being estimated to be keywords in which the user is next interested;
acquiring, based on the second interest keywords, recommendation information items on one or more third documents which are candidates to be browsed after the first document; and
presenting the recommendation information items.

11. A non-transitory computer readable medium including computer executable instructions, wherein the instructions, when executed by a processor, cause the processor to perform a method comprising:
inputting a first document browsed by a user, and a second document which has been browsed before the first document;
extracting one or more first subject keywords from the first document;
extracting one or more second subject keywords from the second document;
extracting one or more first interest keywords from the first subject keywords and the second subject keywords;
extracting one or more second interest keywords from the first subject keywords and the second subject keywords, based on information items specifying the first document and the second document, the first interest keywords, the first subject keywords, and the second subject keywords, the second interest keywords being estimated to be keywords in which the user is next interested;
acquiring, based on the second interest keywords, recommendation information items on one or more third documents which are candidates to be browsed after the first document; and
presenting the recommendation information items.
